(19) United States
(12) Patent Application Publication
(10) Pub. No.: US 2003/0075515 A1
(43) Pub. Date: Apr. 24, 2003

(54) Apparatus for the treatment of oil-containing sludge and methods of doing the same

(76) Inventor: Roger Maki, Watford City, ND (US)

Correspondence Address: CONNOLLY BOVE LODGE & HUTZ LLP, SUITE 800, 1990 M STREET NW, WASHINGTON, DC, 20036-3425, US

(21) Appl. No.: 10/145,143

(22) Filed: May 15, 2002

Related U.S. Application Data
(60) Provisional application No. 60/330,467, filed on Oct. 23, 2001.

(51) Int. Cl. C02F 11/00

(52) U.S. Cl. 210/806; 210/258

(57) ABSTRACT

An oil recovery system that separates oil hydrocarbons from an oil-containing sludge. The oil recovery system includes a sludge containment vessel, and a primary separation unit to remove large solids from a sludge mixture that forms in the sludge containment vessel. The primary separation unit is selected from a shale shaker, a centrifuge, or a filter press. The invention is also directed to a method of separating oil from an oil-containing sludge.

### FIELD OF THE INVENTION

This invention is directed to an apparatus for the treatment of oil-containing sludge, particularly oil sludge from oil storage tanks. This invention is also directed to a method of recovering the fuel value from the oil-containing sludge using the apparatus of the invention.

### BACKGROUND OF THE INVENTION

There are numerous sources that produce organic hydrocarbon or oil-containing waste sludge. Due to environmental regulations and lack of landfill space, there is an increased desire to treat oil-containing sludge in an economically feasible manner. Treatment methods for either reclaiming or disposing of oil-containing sludge vary depending on the chemical makeup of the sludge. A particular problem arises with removal and treatment of oil-containing sludge that accumulates on the bottom of crude oil storage tanks. A percentage of heavy crude oil often contains oil in globular form. Also, oil pumped from the ground contains sediment. As the crude oil is put into storage tanks, the globular oil and sediment settles to the bottom of the tank. As successive loads of crude oil are transitioned through the tank, a thick layer of oil-containing sludge accumulates in the bottom of the tank. This oil-containing sludge is commonly referred to as crude oil tank bottoms or crude oil sludge.

A vacuum truck is often used to remove oil-containing sludge from crude oil tank tanks, flat tank clean out, and reserve pit clean out. However, removal of the oil sludge from the vacuum truck creates another problem. Steam can be used to remove most traces of the oil sludge from the tank into an oil pit. However, this increases environmental problems because of the increase volume of waste material to be treated as well as forming the oil pit. This method also requires that any heavy sediment containing sludge be shoveled from the truck. This poses additional costs and safety concerns for the person in direct contact with the sludge. Because of these human and environmental costs involved with completely cleaning vacuum trucks, these trucks are generally cleaned out less than they should be. As a result, oil-containing solids remain in the vacuum truck, thus contaminating other pumped materials hauled by these trucks.

In most instances an oil storage tank is cleaned by first emptying the crude oil from the oil storage tank. A vacuum truck using vacuum hoses removes the remaining tank bottoms or oil-containing sludge into the vacuum truck tank. The vacuum truck is then driven to a steam plant.

At the steam plant, the vacuum truck is initially checked to determine whether gases, e.g., H₂S, are present in the liquid or solid wastes. If gases are present, the vacuum truck is connected to a steam source and the truck contents are processed or steamed for approximately eight hours. After steaming, the vacuum truck is allowed to cool, generally overnight. This cooling period results in further downtime of the vacuum truck. The vacuum truck with the steamed waste is then driven to a disposal site.

At the disposal site, the steamed wastes are removed from the vacuum truck to a disposal well. The associated costs of pumping the sludge solids down the disposal well can be quite high because the solids quickly wear down the disposal pumps resulting in increased maintenance and operational costs. Also, the heavier solids that cannot be pumped down the well remain in the vacuum truck and must be disposed at yet another location. These remaining solids are taken to a reserve pit and hand-shoveled from the vacuum truck. Hand shoveling of the solid wastes from the vacuum truck bottom is a time consuming and labor intensive process resulting in further downtime of the vacuum truck.

As a result, there remains the need for an effective apparatus and method for treating crude oil tank bottom sludge transported by vacuum trucks. It is also desirable that the same apparatus can be used to process the sludge so that the fuel value contained in the sludge can be recovered.

### SUMMARY OF THE INVENTION

The invention is directed to an oil recovery system that includes a sludge containment vessel and a primary separation unit. In the one embodiment, the sludge containment vessel is positioned above the primary separation unit so the sludge mixture in the sludge containment vessel can be gravity fed to the primary separation unit. Preferably, the primary separation unit includes one or more vibrating screens to remove large solids from the sludge mixture that forms in the sludge containment vessel. This separation unit is commonly referred to in the oil industry as a shale shaker. Alternatively, the primary separation unit includes a separation unit selected from a centrifuge or a filter press. A vacuum source connected to the sludge containment vessel is preferably used to facilitate transfer of the oil containing sludge from a sludge source, typically a vacuum truck, to the sludge containment vessel.

In one embodiment, the oil recovery system includes a sludge containment vessel with a heating element and a fluid injection system disposed within an interior volume of the sludge containment vessel, a primary separation unit with one or more vibrating screens to remove large solids from a sludge mixture that forms in the sludge containment vessel, and a holding tank to contain solids not removed from the sludge mixture, oil hydrocarbons, and water.

The invention is also directed to a method for separating oil hydrocarbons from an oil-containing sludge. The method includes transferring the oil-containing sludge to a sludge containment vessel, removing oil that separates from the oil-containing sludge from the sludge containment vessel through an oil output, wherein the separated oil migrates towards the top of the sludge containment vessel, and removing solids from the sludge mixture with a primary separation unit positioned below the sludge containment vessel.

The method of the invention optionally includes heating the oil-containing sludge to a temperature of at least 130° F. with a heating element disposed within an interior volume of the sludge containment vessel, and/or injecting a fluid into the oil-containing sludge through a fluid injection system disposed within an interior volume of the sludge containment vessel.

### BRIEF DESCRIPTION OF THE DRAWINGS

The invention will be better understood by reference to the Detailed Description of the Invention when taken together with the attached drawing, wherein:

FIG. 1 is schematic of the oil recovery system of the invention.

### DETAILED DESCRIPTION OF THE INVENTION

The invention is directed to an oil recovery system that includes one or more sludge containment vessels, one or more separation units, and one or more holding tanks for the storage of extracted oil, storage of excess sludge, storage for wash fluids, and storage of processed solids. The oil recovery system treats oil-containing sludge from various sources associated with the oil industry, particularly the oil drilling industry. An example list of sources include crude oil tank bottoms, treater clean out, crude oil spills, circulating tanks used in oil drilling, and reserve pits. Under ideal conditions, the oil recovery system extracts greater than 40% by weight, preferably greater than 60% by weight, of the oil from the oil-containing sludge.

One problem associated with present oil recovery systems is that oil-containing sludge and partially processed sludge is pumped from one system component to another. The solids in the sludge cause the pumps to clog or repeatedly fail if the pumps are not properly maintained. Also, the sludge solids place a great deal of wear and tear on the pumps, which results in additional down time and additional costs. For example, present oil recovery systems pump oil-containing sludge from a vacuum truck to a sludge vessel. The pumps are not able to remove the relatively large sludge solids and high viscous sludge from the tank of the vacuum truck. These materials collect in the truck tank and later have to be physically removed as already described. In another example, present oil recovery systems transfer sludge from the sludge vessel to a separation unit. Again, the pumping of the sludge causes the pumps to fail or at least regular maintenance of the pumps is required. As a result, the system is often off-line because the pumps have to be cleaned regularly to maintain operation. The present invention minimizes the amount sludge that is transferred by pumps or similar devices.

The oil recovery system of the invention comprises a sludge containment vessel and a primary separation unit. In the preferred embodiment, the sludge containment vessel is positioned above the primary separation unit so the sludge mixture in the sludge containment vessel can be gravity fed to the primary separation unit. Preferably, the primary separation unit includes one or more vibrating screens to remove large solids from the sludge mixture that forms in the sludge containment vessel. This separation unit is commonly referred to in the oil industry as a shale shaker. Alternatively, the primary separation unit includes a separation unit selected from a centrifuge or a filter press. The sludge containment vessel can include a heating element and a fluid injection system disposed within an interior volume of the sludge containment vessel. Also, a holding tank is generally used to contain solids, oil hydrocarbons, and water not removed from the sludge mixture by the primary separation unit. A secondary separation unit can then process these solids for removal of additional solids and/or these solids can be returned to the sludge containment vessel for additional processing.

Generally, a vacuum truck is used to transport oil-containing sludge, particularly oil-containing sludge from oil storage tanks in the field, to the oil recovery system. Most, if not all, of the sludge is removed from the vacuum truck to the sludge containment vessel with a vacuum source, preferably a vacuum pump. The vacuum source is connected to the sludge containment vessel. The reduced pressure in the sludge containment vessel is used to facilitate transfer of the oil-containing sludge from the vacuum truck. Nearly complete removal of the oil-containing sludge is possible because the vacuum trucks can be cleaned more frequently due to the advantages gained with the vacuum system of the oil recovery system. The vacuum pump is positioned off-line so solids do not pass through the pump. In essence, the sludge containment vessel of the invention functions as one very large vacuum vessel.

It is desirable, that the truck be cleaned after each transfer of oil-containing sludge from the storage tanks to the oil recovery plant. However, once a day or once a week cleaning is also possible depending on the type and the amount of solids in the oil-containing sludge. It is to be understood that the term “cleaned” is used to mean that greater that 90% by volume, preferably greater than 95% by volume, of the oil-containing sludge is removed from the vacuum truck to the sludge containment vessel.

The sludge containment vessel preferably contains a fluid injection system positioned proximate to the bottom portion of the sludge containment vessel. The fluid injection system provides for the addition of a fluid, preferably water from a convenient and inexpensive source, into the oil-containing sludge proximate to the bottom of the sludge containment vessel. The injected fluid is used to break-up the sludge mixture, and to provide a means for the separated oil to migrate and collect toward the top volume portion of the sludge mixture in the sludge containment vessel. The injection of the fluid aids in the separation of the oil from the solids that settle to the bottom of the sludge containment vessel. The term “sludge mixture” is defined as any oil-containing sludge that has been heated or injected with fluid in the sludge containment vessel.

In the preferred embodiment, a skimming element is used to push the oil that collects at the top of the sludge contents in the sludge containment vessel. In one embodiment, a spray bar is used to transfer the separated oil from the top of the sludge volume to an oil output. The oil output is connected to an oil output line, which directs the extracted oil to one or more tanks. The spray bar is positioned proximate to and within the top portion of the sludge containment vessel. Preferably, water from the spray bar forces the oil to the oil output and into oil holding tanks. The water can then be easily separated from the extracted oil.

A primary separation unit is positioned downstream from the sludge containment vessel. In one embodiment, the primary separation unit is positioned directly below the sludge containment vessel. This configuration allows gravity to feed the solids from the bottom of the sludge containment vessel to the primary separation unit. The primary separation has one or more vibrating screens. Such a separation device is commonly known to those of ordinary skill in the art as a shale shaker.

Positioning a shale shaker directly below the sludge containment vessel allows the sludge bottoms or solids to be gravity fed to the shale shaker. This configuration provides several advantages. First, optimal flow control of solids to the shale shaker is achieved without the use of pumps or filters preceding the pumps. As a result, there tends to be less down time due to plugged pumps or filters. Second, the larger solids that do not initially pass through the screen of the shale shaker can be discarded. The solids that pass through the screen of the shale shaker can be directed to a secondary shale shaker with a smaller porosity screen. Alternatively, these solids can be returned to the sludge containment vessel for additional processing. The size screen of the shale shaker is selected for optimal cost efficiency of solid removal. Third, there is no need for a constrictive valve between the sludge containment vessel and the shale shaker to control the flow of solids. In lateral control configurations, these valves tend to clog over time, and thus contribute to the down time of an oil recovery system.

If secondary separation devices are used in the invention, the use of the shale shaker as described above provides greater process efficiency of solid separation in the secondary separation devices for the following reason. There are less solids that get directed to the secondary separation devices because at least 30% by weight, preferably at least 50% by weight, of the solids contained in the sludge mixture will already have been removed by the shale shaker. As a result, there is less wear and tear on the component of the secondary separation devices. The secondary separation devices are selected from a shale shelter, a centrifuge or a filter press.

The sludge containment vessel can also include a heating element e.g., a heat exchanger, within the interior volume of the sludge containment vessel. The heating element is used to control the temperature of the oil-sludge in the sludge containment vessel. Often, the temperature of the sludge mixture is raised to facilitate the separation of the oil from the solids. The amount of heat provided to the sludge mixture will vary according to a number of factors, including such things as, the temperature of the operating environment, the chemical makeup of the oil-containing sludge, and the amount of water in the sludge.

All components of the oil recovery system including the holding tanks can include depth measurement controls and an inlet shut-off switch that is activated should the material within the system component or holding tank exceed a predetermined level. Also, the oil recovery system can include flow control and flow measurement devices that monitors the quantity of fluids used in the process or the amounts of solids transferred from one system component to another at various stages of processing.

The flow of the oil-containing sludge and the respective separated oil and solids in the oil recovery system can be controlled either manually or automatically. If the control is automatic, it is contemplated that the system will be provided with a means to manually override the automatic control in the event the operator determines a change in the treatment parameters is warranted.

It is highly desirable that substantially complete extraction of fuel value oil from the oil-containing sludge be achieved. In one embodiment, greater than 40% by weight, preferably greater than 60% by weight, of fuel-value oil in the oil containing sludge is extracted.

Following the extraction of the oil from the solids, the solids can be disposed in a landfill at reduced cost because of the reduction in volume as well as the reduction in hydrocarbon content.

Another advantage resulting from the invention is that the vacuum trucks used to transport the oil-containing sludge from the field to the oil recovery system remain free of accumulated sludge. Because the apparatus of the invention provides an economical route to remove oil-containing sludge from vacuum trucks, there is no build-up of thick oil sludge in the bottom of the truck tank. The oil-containing sludge can be removed from the vacuum truck in two hours or less, and return to the field with a relatively clean tank to pick up an additional load. Also, the vacuum truck is freed for use for other purposes, e.g., fresh water casing (backside) of oil well, without the concern of contaminating other transported materials with oil sludge. This lowers the cost of the salt-water disposal plant because there is less solids and contamination in the transported water, which translates to lower filtering costs. Also, the vacuum truck can haul more product because of the increased volume of the tank between loads.

At present, it takes about sixteen hours or more for a vacuum truck to be cleaned because the oil sludge is allowed to accumulate in the truck tank over a period of several loads. Also, the vacuum trucks filled in part with oil sludge contaminate salt water supplies and provide additional cost to the salt water disposal plant.

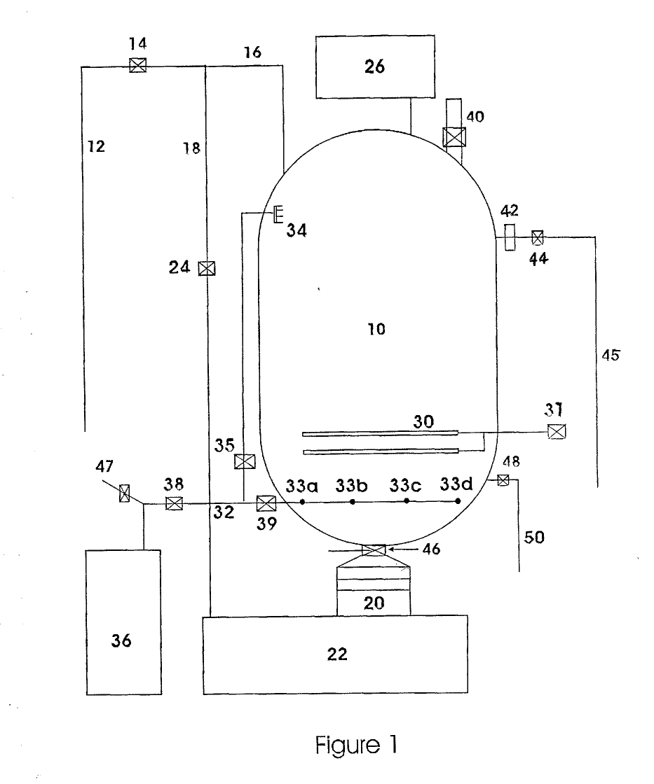

FIG. 1 depicts one embodiment of the oil recovery system of the invention. Oil containing sludge is transferred from a vacuum truck to a sludge containment vessel 10 via a transfer line 12, which includes an intake valve 14. The oil containing sludge is added to the sludge containment vessel 10 via input line 16. Input line 16 includes oil-containing sludge from return line 18. Return line 18 is used to return processed solids from a tank 22, that is, solids that have already passed through a shale shaker 20. The return line 18 includes a return valve 24 to control the flow of processed solids to input line 16. A vacuum pump 26 is used to transfer the oil-contaminated sludge from the vacuum truck as well as the processed solids from the tank 22 to the sludge containment vessel 10.

The sludge containment vessel includes one or more heating elements 30, preferably a heat exchanger, whose temperature is controlled with heat exchange valve 31, injection line 32 with injection nozzles 33a, 33b, 33c, and 33d, and spray nozzle 34. The flow of fluid from a fluid holding tank 36 to the injection line 32 is controlled by fluid control valve 38 and 39. The flow of fluid from fluid holding tank 36 to spray nozzle is controlled by spray valve 35. The sludge containment vessel also includes a gas relief valve 40 and oil output line 45. Oil output line 45 preferably includes a filter 42 positioned in front of oil output valve 44, which controls the flow of extracted oil from the sludge containment vessel 10 to the tanks holding the extracted oil. Solid exit valve 46 controls the flow of solids form sludge containment vessel 10 to shale shaker 20.

Shale shaker 20 fitted with a shaker screen separates solids from the sludge containment vessel 10 according to size. The porosity of the shaker screen can be interchanged to optimize process efficiencies of various downstream separation units in the oil recovery system as well as optimize oil separation from the solids. Any common type of shale shaker known in the art of sludge treatment can be used in the apparatus of the invention. A shale shaker described in U.S. Pat. No. 5,641,070, the complete disclosure of which is incorporated herein by reference, is one example of a shale shaker that can be used in the oil recovery system of the invention.

The relatively large solids separated from the shale shaker can be disposed in a landfill. The smaller solids separated along with some fluids, generally an oil water emulsion, from the shale shaker 20 are directed to tank 22. These solids and fluids can be returned to sludge containment vessel 10 via return line 18 for further processing, i.e., additional oil separation.

In the preferred embodiment, shale shaker 20 has at least two separate screen sections, each at a 3° to 5° upward angle, arranged so that the vibratory forces cause the solids to “climb” up the topmost screen and “fall” onto the next lower section, repeating the process until the solids drop into a discard tank for later disposal. To prevent the vibrating screens from clogging, the screens are sprayed with oscillating spray nozzles with water, preferably from fluid tank 36.

The solids and fluid that collect in tank 22 can also be directed to a second sludge containment vessel, preferably a vacuum vessel, and then directed to a secondary separation unit such as a second shale shaker, a centrifuge or filter press. The secondary separation unit removes solids not removed by the primary separation unit. A three stage centrifuge especially adapted to the separation of oil, water, and solid particles can be used to separate sediment and water from the oil. The three stage centrifuge includes a rotatable bowl that spins the mixture to separate the oil and water into separate pools within the bowl. The solid particles are also moved radially outward within the rotatable bowl by centrifugal force. A conveyor auger contacts the solid particles and discharges the solids from the rotatable bowl through a solids discharge port. The solid can be discarded. Oil discharge tubes contact the oil pool confined between oil baffle plates on the conveyor auger and allow the oil to be discharged from the rotatable bowl. Water weirs contact the water pool and allow the water to be discharged from the rotatable bowl.

A filter press that can be used as a primary or secondary separation unit is described in U.S. Pat. No. 5,804,070, the entire disclosure, including the U.S. patent references cited therein, of which is incorporated herein by reference.

The oil that separates from the sludge solids migrates toward the top of the volume contents of the sludge containment vessel 10. The injection of fluid from fluid tank 36 through nozzles 33a, 33b, 33c, and 33d are used to break up the sludge that settles in the bottom of sludge containment vessel 10. The injection of the fluid also facilitates the migration of the separated oil to the top of the sludge containment vessel 10.

The separated oil that migrates toward the top of the sludge containment vessel, and generally floats on top of the fluid, which is preferably salt or fresh water. The floated oil is then directed to an exit port with the help of fluid from spray nozzle 32. The oil/fluid cut taken from the top of sludge containment vessel can be rough filtered by a filter 42. The oil/fluid cut can be stored in tanks for further processing or directed to secondary separation or filtration units to remove any fluid and additional sediments that are mixed with the oil. The cleaned oil can be stored in tanks to await transfer to a refinery.

At times it may be necessary to store a portion of a sludge mixture in storage tanks for additional processing. Preferably, the sludge mixture has been treated in some way, preferably by a once through the primary separation unit before storage. The sludge mixture can be removed from the sludge containment vessel 10 via sludge out line 50 through sludge valve 48 to one or more sludge holding tanks.

Operation of the oil recovery system, including the sludge containment vessel, can be conducted in a batch, semi-batch, or continuous process. In a batch process, oil-containing sludge from a vacuum truck is transferred to sludge containment vessel 10 by the reduced pressure produced by vacuum pump 26. Most of the remaining oil-containing sludge in the vacuum truck can be transferred to sludge containment vessel after first washing the truck tank with fluid using wash line 47. A wand is used with the fluid to push the sludge to vacuum line 12. Use of the wand allows the truck to be cleaned relatively quickly with minimal contact by an operator. The remaining sludge and fluid are then pumped into the sludge containment vessel. The vacuum truck is now cleaned, and can return to the field without the concern of contaminating non-sludge containing loads.

With the sludge containment vessel filled with the oil-containing sludge, the sludge can be heated with a heat exchanger 30. Generally, steam is used to as a heat source. The temperature of the sludge in the sludge mixture containment vessel is raised to at least 130° F., preferably to at least 160° F., and more preferably to at least 190° F. After the recovery plant reaches an optimal temperature, valve 44 is opened so any separated oil that migrates to the top of the volume contents can be discharged from the sludge containment vessel. Additional oil can be separated from the sludge that settles to the bottom of the sludge containment vessel by injecting fluid through the injection nozzles. Following injection of the fluid, an optimal period of time is provided to allow the sludge to again settle to the bottom and the separated oil to float to the top. The process can be repeated any number of times to optimize separation efficiency of the oil from the sludge and solids.

The solids that collect in the bottom of the sludge containment vessel are directed to shale shaker 20. The fluid and solids that pass through the vibrating screens of the shale shaker are directed to tank 22. The solids in tank 22 can be directed back to the sludge containment vessel via return line 18. Heat can again be applied, and the process repeated. However, now the relatively large solids have already been removed from the original sludge volume. After the first pass, the vibrating screens of the shale shaker are interchanged with relatively finer screens. This sifting and separation process can be repeated until the desired amount of oil has been extracted and solids removed for disposal.

The addition of a secondary separation unit to the oil recovery system of the invention facilitates operation of the oil recovery system in a semi-batch or continuous mode. The oil-containing sludge is transferred from the sludge source, typically a vacuum truck, to the sludge containment vessel. The oil-containing sludge is heated and/or injected with a fluid to facilitate separation of the oil from the solids. The solids that settle to the bottom of the sludge containment vessel fall into the primary separation unit, which removes the relatively large solids from the settled sludge. The remaining solids, oil, and water from the primary separation unit is then directed to a holding tank or directly to a secondary separation unit for additional solid removal and fluid separation. The solids removed from the secondary unit can be disposed of in a landfill. Having now fully described this invention, it will be appreciated by those skilled in the art that the invention can be performed within a range of parameters within what is claimed, without departing from the spirit and scope of the invention.

We claim:

1. An oil recovery system for separating oil hydrocarbons from an oil-containing sludge comprising a sludge containment vessel and a primary separation unit, wherein the sludge containment vessel is positioned above the primary separation unit so a sludge mixture in the sludge containment vessel drops into the primary separation unit.

2. The oil recovery system of claim 1 wherein the sludge containment vessel includes a heating element and a fluid injection system disposed within an interior volume of the sludge containment vessel.

3. The oil recovery system of claim 1 wherein the primary separation unit includes one or more vibrating screens to remove large solids from a sludge mixture that forms in the sludge containment vessel.

4. The oil recovery system of claim 1 wherein the primary separation unit includes a separation unit selected from the group consisting of a centrifuge and a filter press.

5. The oil recovery system of claim 1 further comprising a holding tank to contain solids, oil hydrocarbons, and water not removed from the sludge mixture by the primary separation unit.

6. The oil recovery system of claim 1 wherein the sludge containment vessel includes an oil output that connects with the sludge containment vessel at a location to remove oil that separates from the sludge mixture and migrates toward the top of the sludge containment vessel.

7. The oil recovery system of claim 6 wherein the sludge containment vessel includes a skimming device in the interior volume to direct the oil that separates from the sludge mixture to the oil output.

8. The oil recovery system of claim 1 wherein the sludge containment vessel is connected to a vacuum source, wherein the vacuum source provides reduced pressure in the sludge containment vessel to facilitate transfer of the oil-containing sludge from a sludge source selected from a vacuum truck, oil storage tank, or a reserve pit to the sludge containment vessel.

9. The oil recovery system of claim 5 further comprising a return line that connects the holding tank to the sludge containment vessel to direct solids not removed from the sludge mixture to the sludge containment vessel.

10. The oil recovery system of claim 1 further comprising a secondary separation unit selected from the group consisting of a separation unit with one or more vibrating screens, a centrifuge, and a filter press, wherein the secondary separation unit removes solids not removed by the primary separation unit.

11. An oil recovery system for separating oil hydrocarbons from an oil-containing sludge comprising:
a sludge containment vessel connected to a vacuum source, wherein the vacuum source provides reduced pressure in the sludge containment vessel to facilitate transfer of the oil-containing sludge from a sludge source selected from a vacuum truck, oil storage tank, or a reserve pit to the sludge containment vessel;
a primary separation unit with one or more vibrating screens to remove large solids from a sludge mixture that forms in the sludge containment vessel.

12. The oil recovery system of claim 11 wherein the sludge containment vessel includes an oil output that connects with the sludge containment vessel at a location to remove oil that separates from the sludge mixture and migrates toward the top of the sludge containment vessel.

13. The oil recovery system of claim 12 wherein the sludge containment vessel includes a skimming device in the interior volume to direct the oil that separates from the sludge mixture to the oil output.

14. The oil recovery system of claim 13 wherein the skimming device includes a spray member positioned proximately across the sludge containment vessel from the oil output and above the oil output.

15. The oil recovery system of claim 11 wherein the sludge containment vessel includes a heating element disposed within an interior volume of the sludge containment vessel positioned proximate to the bottom of the sludge containment vessel.

16. The oil recovery system of claim 11 further comprising a return line that directs solids not removed by the primary separation unit to the sludge containment vessel.

17. The oil recovery system of claim 11 wherein the sludge containment vessel includes a fluid injecting system disposed in the bottom third of an interior volume of the sludge containment vessel.

18. The oil recovery system of claim 11 further comprising a secondary separation unit selected from the group consisting of a second separation unit with one or more vibrating screens, a centrifuge, and a filter press, wherein the secondary separation unit removes solids not removed by the primary separation unit.

19. The oil recovery system of claim 11 wherein the sludge containment vessel is positioned above the primary separation unit so the sludge mixture in the sludge containment vessel drops into the primary separation unit.

20. A method for separating oil hydrocarbons from an oil-containing sludge comprising:
transferring the oil-containing sludge to a sludge containment vessel;
removing oil that separates from a sludge mixture from the sludge containment vessel through an oil output, wherein the separated oil migrates towards the top of the sludge containment vessel; and
removing solids from the sludge mixture with a primary separation unit positioned below the sludge containment vessel.

21. The method of claim 20 further comprising injecting a fluid into the oil-containing sludge through a fluid injection system disposed within an interior volume of the sludge containment vessel.

22. The method of claim 20 further comprising directing solids not removed from the sludge mixture with the primary separation unit to a holding tank.

23. The method of claim 20 further comprising directing solids not removed from the sludge mixture with the primary separation unit to a secondary separation unit selected from the group consisting of a second separation unit with one or more vibrating screens, a centrifuge, and a filter press.

24. The method of claim 22 further comprising directing solids from the holding tank back to the sludge containment vessel.

25. The method of claim 20 wherein removing oil from the sludge containment vessel through an oil output comprises pushing the separated oil toward the oil output with a skimming device.

26. The method of claim 20 wherein transferring the oil-containing sludge to a sludge containment vessel includes a vacuum source, wherein the vacuum source provides reduced pressure in the sludge containment vessel to facilitate transfer of the oil-containing sludge from a sludge source selected from a vacuum truck, oil storage tank, or a reserve pit to the sludge containment vessel.

27. The method of claim 20 wherein the removed oil accounts for greater than 40% by weight of the oil in the oil-containing sludge.

28. The method of claim 20 wherein the removed oil accounts for greater than 60% by weight of the oil in the oil-containing sludge.

29. The method of claim 20 wherein removing solids from the sludge mixture with the primary separation unit comprises gravity feeding the sludge mixture to the primary separation unit from the sludge containment vessel which is positioned above the primary separation unit.

30. The method of claim 20 further comprising heating the oil-containing sludge to a temperature of at least 130° F. with a heating element disposed within an interior volume of the sludge containment vessel.
